(19) United States
(12) Patent Application Publication
(10) Pub. No.: US 2026/0186104 A1
(43) Pub. Date: Jul. 2, 2026

(54) FOCAL PLANE ARRAY SYSTEM AND LIDAR DEVICE INCLUDING THE SAME

(71) Applicant: SAMSUNG ELECTRONICS CO., LTD., Suwon-si (KR)

(72) Inventors: Sunghyun NAM, Suwon-si (KR); Joonyong PARK, Suwon-si (KR)

(73) Assignee: SAMSUNG ELECTRONICS CO., LTD., Suwon-si (KR)

(21) Appl. No.: 19/234,824

(22) Filed: Jun. 11, 2025

(30) Foreign Application Priority Data
Dec. 30, 2024 (KR) 10-2024-0201133

(51) Int. Cl. G01S 7/481; G01S 17/58

(52) U.S. Cl. CPC G01S 7/4815; G01S 17/58

(57) ABSTRACT

A focal plane array system includes a plurality of pixels configured to output a first signal light beam and to receive a second signal light beam reflected from a target object. Each of the plurality of pixels includes a transmitter, a receiver, and an interference light beam controller that includes a splitter disposed on an emission path of the first signal light beam to split a portion of the first signal light beam into an interference light beam, a receiving coupler disposed on a receiving path of the second signal light beam reflected from the target object, and a waveguide configured to transport the interference light beam split from the splitter to the receiving coupler. The receiving coupler is configured to transport the second signal light beam reflected from the target object to the receiver and to combine the interference light beam with the second signal light beam.

### CROSS-REFERENCE TO RELATED APPLICATIONS

This application claims priority under 35 U.S.C. § 119 to Korean Patent Application No. 10-2024-0201133, filed on Dec. 30, 2024, in the Korean Intellectual Property Office, the disclosure of which is incorporated by reference herein in its entirety.

### BACKGROUND

### 1. Field

The present disclosure relates generally to detection and ranging systems, and more particularly, to a focal plane array system and a light detection and ranging (LiDAR) device including the focal plane array system.

### 2. Description of the Related Art

LiDAR devices may be used in various fields such as, but not limited to, autonomous driving devices (e.g., driver-less vehicles, autonomous vehicles, drones, robots, or the like), or precision measuring devices.

LiDAR operation methods may be classified, for example, into a pulse method and a continuous wave method. For example, the continuous wave method may have advantages of relatively low peak output, higher safety, and/or higher light efficiency, when compared to other LiDAR operation methods. As another example, a frequency-modulated continuous wave (FMCW) method may obtain four-dimensional information (4D) that may include distance information and velocity information about an object in real time through modulation that may linearly increase and/or decrease a frequency of an output light and may have relatively strong noise-resistant characteristics, when compared to other LiDAR operation methods.

The FMCW method may have a relatively high distance resolution and/or velocity resolution even in an environment with ambient noise, and may use a light source with relatively low peak power. Thus, the FMCW method may be suitable for implementing silicon photonics-based LiDAR, in which it may be difficult to secure a relatively high light output.

In addition to measuring a distance and/or a velocity to objects with high precision in a LiDAR system, the LiDAR system may scan a space (e.g., an x-y plane) in the front of the LiDAR with relatively high resolution to distinguish the objects. Scanning technologies may be classified into methods that may include, but not be limited to, flash, mirror-scanning, optical phased array (OPA), dispersive, focal plane array (FPA), or the like. These scanning methods may be used alone or in combination along an x-y axis to scan a forward space. Among these scanning methods, the FPA method may have relatively low complexity of control technology compared to other technologies and may have improved side mode suppression ratio (SMSR) characteristics, and thus, the FPA method may be suitable for an FMCW driving method.

Beam scanning methods using silicon photonics may include methods using the OPA and methods using the FPA. Among these, the methods using the FPA having a relatively low complexity and improved SMSR characteristics may be suitable for the FMCW driving method.

### SUMMARY

One or more example embodiments of the present disclosure provide a focal plane array system that may be suitable for implementing silicon photonics-based light detection and ranging (LiDAR) while minimizing in-plane light loss and a LiDAR device including the same.

Further, one or more example embodiments of the present disclosure a focal plane array system suitable for a frequency-modulated continuous wave (FMCW) driving method and a LiDAR device including the same.

Additional aspects be set forth in part in the description that follows and, in part, may be apparent from the description, and/or may be learned by practice of the presented embodiments of the present disclosure.

According to an aspect of the present disclosure, a focal plane array system includes a plurality of pixels configured to output a first signal light beam and to receive a second signal light beam reflected from a target object. Each of the plurality of pixels includes a transmitter including a laser element configured to emit the first signal light beam, a receiver including a photodetector configured to receive the second signal light beam, and an interference light beam controller. The interference light beam controller includes a splitter disposed on an emission path of the first signal light beam to split a portion of the first signal light beam into an interference light beam, a receiving coupler disposed on a receiving path of the second signal light beam reflected from the target object, and a waveguide configured to transport the interference light beam split from the splitter to the receiving coupler. The receiving coupler is configured to transport the second signal light beam reflected from the target object to the receiver and to combine the interference light beam with the second signal light beam. A first direction in which the first signal light beam proceeds from the transmitter to the splitter is different from a second direction in which the interference light beam proceeds to the waveguide.

In some embodiments, in the focal plane array system, the splitter, the receiving coupler, and the waveguide may be provided in a same plane.

In some embodiments, in the focal plane array system, the splitter may include a transmitting grating coupler that may couple the portion of the first signal light beam to the waveguide as the interference light beam. The receiving coupler may include a receiving grating coupler that may be configured to transport the second signal light beam reflected from the target object to the receiver and may combine the interference light beam with the second signal light beam.

In some embodiments, in the focal plane array system, the transmitting grating coupler, the waveguide, and the receiving grating coupler may be formed to be coupled with each other in a same plane.

In some embodiments, in the focal plane array system, the transmitting grating coupler and the receiving grating coupler may include a tapered shape with a width that may narrow toward the waveguide.

In some embodiments, in the focal plane array system, the laser element may include an array of a plurality of coherent laser elements.

In some embodiments, in the focal plane array system, the transmitting grating coupler may be further configured to at least partially overlap the second signal light beam emitted from at least one of the plurality of coherent laser elements.

In some embodiments, in the focal plane array system, the splitter may include a plurality of splitters that may be spaced apart from each other. The receiving coupler may include a plurality of receiving couplers disposed between the plurality of splitters. The waveguide may be configured to couple a first splitter of the plurality of splitters with a first receiving coupler of the plurality of receiving couplers. The first splitter may be adjacent to the first receiving coupler. The transmitter may further include a beam scanner that may be configured to scan the first signal light beam emitted from the laser element to be sequentially input into the plurality of splitters. The photodetector may include a plurality of photodetectors corresponding to the plurality of receiving couplers.

In some embodiments, in the focal plane array system, the splitter may further include a transmitting grating coupler that may be configured to couple the portion of the first signal light beam to the waveguide as the interference light beam. The receiving coupler may further include a receiving grating coupler that may be configured to transport the second signal light beam reflected from the target object to the receiver and to combine the interference light beam with the second signal light beam.

In some embodiments, in the focal plane array system, the splitter may include an omnidirectional coupler. The waveguide may include a plurality of waveguides that may be disposed radially to be coupled with the omnidirectional coupler. The receiving coupler may include a plurality of receiving grating couplers that may be coupled with each of the plurality of waveguides. Each pixel of the plurality of pixels may include a plurality of subpixels.

In some embodiments, in the focal plane array system, the omnidirectional coupler, the waveguide, and the plurality of receiving grating couplers may be formed to be coupled with each other in a same plane.

In some embodiments, in the focal plane array system, each of the plurality of receiving grating couplers may include a tapered shape with a width that may narrow toward the waveguide.

In some embodiments, in the focal plane array system, the transmitter may include a first micro lens that may be configured to condense the first signal light beam emitted from the laser element. The receiver may include a second micro lens that may be configured to converge the interference light beam with the second signal light beam reflected from the target object onto the photodetector. The laser element and the photodetector may be provided in a first substrate. The first micro lens and the second micro lens may be provided in a second substrate different from the first substrate.

In some embodiments, in the focal plane array system, the splitter may include a first meta surface lens that may be configured to condense the first signal light beam emitted from the laser element and to couple the portion of the first signal light beam into the waveguide as the interference light beam. The receiving coupler may include a second meta surface lens that may be configured to combine a portion of the interference light beam with the second signal light beam reflected from the target object, and to converge the combined signal light beam onto the photodetector. The laser element and the photodetector may be provided in a first substrate. The first meta surface lens and the second meta surface lens may be provided in a second substrate different from the first substrate.

According to an aspect of the present disclosure, a light detection and ranging (LiDAR) device includes a focal plane array system including a plurality of pixels configured to output a first signal light beam and to receive the second signal light beam reflected from a target object, and a processor configured to calculate information of the target object. Each of the plurality of pixels includes a transmitter including a laser element configured to output the first signal light beam, a receiver including a photodetector configured to receive a light beam, and an interference light beam controller. The interference light beam controller includes a splitter disposed on an emission path of the first signal light beam to split a portion of the first signal light beam into an interference light beam, a receiving coupler disposed on a receiving path of the second signal light beam reflected from the target object, and a waveguide configured to transport the interference light beam split from the splitter to the receiving coupler. The receiving coupler is configured to transport the second signal light beam reflected from the target object to the receiver and to combine the interference light beam with the second signal light beam. A first direction in which the first signal light beam proceeds from the transmitter to the splitter is different from a second direction in which the interference light beam proceeds to the waveguide.

In some embodiments, in the LiDAR device, the splitter, the receiving coupler, and the waveguide may be disposed in a same plane.

In some embodiments, in the LiDAR device, the splitter may include a transmitting grating coupler that may couple the portion of the first signal light beam to the waveguide as the interference light beam. The receiving coupler may include a receiving grating coupler that may be configured to transport the second signal light beam reflected from the target object to the receiver and to combine the interference light beam with the second signal light beam.

In some embodiments, in the LiDAR device, the transmitting grating coupler and the receiving grating coupler may include a tapered shape with a width that may narrow toward the waveguide.

In some embodiments, in the LiDAR device, the splitter may include a plurality of splitters spaced apart from each other. The receiving coupler may include a plurality of receiving couplers disposed between the plurality of splitters. The waveguide may be configured to couple a first splitter of the plurality of splitters with a first receiving coupler of the plurality of receiving couplers. The first splitter may be adjacent to the first receiving coupler. The transmitter may further include a beam scanner that may be configured to scan the first signal light beam emitted from the laser element to be sequentially input into the plurality of splitters. The photodetector may include a plurality of photodetectors corresponding to the plurality of receiving couplers.

In some embodiments, in the LiDAR device, the splitter may include an omnidirectional coupler. The waveguide may include a plurality of waveguides that may be disposed radially to be coupled with the omnidirectional coupler. The receiving coupler may include a plurality of receiving grating couplers that may be coupled with each of the plurality of waveguides. Each pixel of the plurality of pixels may include a plurality of subpixels.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a schematic diagram illustrating a focal plane array (FPA) system, according to an embodiment;

FIG. 2 is a schematic diagram illustrating a pixel structure of a focal plane array system, according to an embodiment of FIG. 1;

FIG. 3 is a schematic diagram illustrating an example of a pixel structure of a focal plane array system, according to an embodiment of FIG. 2;

FIG. 4 is a plan view of an interference light beam controller and a pixel structure of a focal plane array system including the same, according to an embodiment;

FIG. 5 is a plan view of an interference light beam controller and a pixel structure of a focal plane array system including the same, according to an embodiment;

FIG. 6 is a plan view of an interference light beam controller and a pixel structure of a focal plane array system including the same, according to an embodiment;

FIG. 7 is a schematic diagram illustrating an example of a pixel structure of a focal plane array system according to an embodiment of FIG. 2, according to an embodiment;

FIG. 8 is a schematic diagram illustrating a focal plane array system, according to an embodiment.

FIGS. 9A to 9D show an example of a method of manufacturing a laser device including a plurality of coherent laser element arrays, according to an embodiment;

FIGS. 10A to 10D show another example of a method of manufacturing a laser device including a plurality of coherent laser element arrays, according to an embodiment;

FIG. 11 is a diagram showing a transmission signal and a reception signal with varying frequencies, and bit signals, according to the transmission signal and the received signal, according to an embodiment;

FIG. 12 is a block diagram of a processor of a LiDAR device, according to an embodiment;

FIG. 13 is a diagram schematically showing a LiDAR device, according to an embodiment;

FIG. 14 is a block diagram schematically showing a configuration of an electronic device including a LiDAR device, according to an embodiment; and

FIG. 15 is a schematic diagram showing an example of applying a LiDAR device to a vehicle, according to an embodiment.

### DETAILED DESCRIPTION

Reference is now be made to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereafter, embodiments are described more fully with reference to the accompanying drawings. In the drawings, like reference numerals refer to like elements, and in the drawings, sizes of constituent elements may be exaggerated for clarity and convenience of explanation. The following embodiments described below are merely illustrative, and various modifications may be possible from the embodiments.

Hereinafter, when a position of an element is described using an expression “above” or “on”, the position of the element may include not only the element being “immediately on/under/left/right in a contact manner” but also being “on/under/left/right in a non-contact manner”. Singular forms may include the plural forms unless the context clearly indicates otherwise. When a part “comprises” or “includes” an element in the specification, unless otherwise defined, it is not excluding other elements but may further include other elements.

The term “above” and similar directional terms may be applied to both singular and plural. With respect to operations that constitute a method, the operations may be performed in any appropriate sequence unless the sequence of operations is clearly described or unless the context clearly indicates otherwise.

It is to be understood that each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

As used herein, when an element or layer is referred to as “covering”, “overlapping”, or “surrounding” another element or layer, the element or layer may cover at least a portion of the other element or layer, where the portion may include a fraction of the other element or may include an entirety of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

Also, in the specification, the term “units” or “ . . . modules” may denote units or modules that may process at least one function or operation, and may be realized by hardware, software, or a combination of hardware and software.

In addition, the connecting lines or connecting members between the components shown in the drawings are merely illustrative of functional connections and/or physical or circuit connections. In a practical device, the connections between the components may be represented by various functional connections, physical connections, or circuit connections that may be replaced or added.

The embodiments herein may be described and illustrated in terms of blocks, as shown in the drawings, which carry out a described function or functions. These blocks, which may be referred to herein as units or modules or the like, or by names such as, but not limited to, device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

As used herein, each of the terms “SiN”, “SiO₂”, “TiO₂”, or the like may refer to a material made of elements included in each of the terms and is not a chemical formula representing a stoichiometric relationship.

Hereinafter, various embodiments of the present disclosure are described with reference to the accompanying drawings.

All examples or example terms (e.g., etc., or the like) may be used to explain the technical scope of the present disclosure, and thus, the scope of the disclosure is not limited by the examples or the example terms as long as it is not defined by the claims.

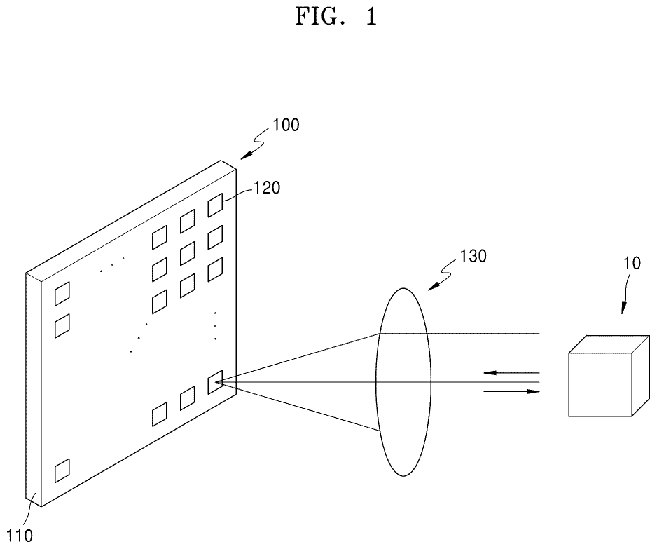

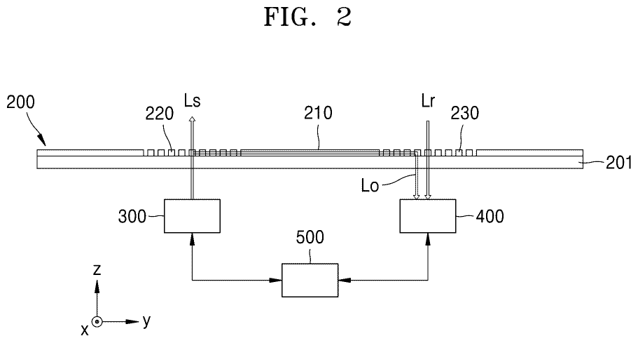

FIG. 1 is a schematic diagram illustrating a focal plane array (FPA) system 100, according to an embodiment. FIG. 2 is a schematic diagram illustrating a structure of a pixel 120 of the focal plane array system 100, according to the embodiment of FIG. 1.

Referring to FIGS. 1 and 2, the focal plane array system 100 may be provided at a focal plane of an imaging lens 130. The focal plane array system 100 may include a photonic integrated circuit (PIC) 110 and a plurality of pixels 120. The plurality of pixels 120 may be two-dimensionally arranged on the photonic integrated circuit 110.

A light detection and ranging (LiDAR) device may include the focal plane array system 100 and a processor 500 and may scan one or more light beams in one dimension (1D) and/or two dimensions (2D) by selectively activating the plurality of pixels 120 of the focal plane array system 100, and the processor 500 may perform calculations to acquire information about a target object 10. Each of the plurality of pixels 120 of the focal plane array system 100 may transmit a signal light beam Ls and/or receive a signal light beam Lr reflected from the target object 10.

The processor 500 may perform a calculation for obtaining information about the target object 10 and may also oversee processing and control of the LiDAR device. The processor 500 may obtain and/or process information about the target object 10. For example, the processor 500 may obtain and process two-dimensional (2D) and/or three-dimensional (3D) image information. The processor 500 may control driving of a transmitter of the focal plane array system 100 and/or an operation of a receiver. For example, the processor 500 may control an electrical signal applied to the transmitter of the focal plane array system 100. The processor 500 may also analyze a distance between the target object 10 and the LiDAR device, a velocity, a shape of the target object 10, or the like, through numerical information provided by the receiver of the focal plane array system 100. A three-dimensional (3D) image acquired by the processor 500 may be transmitted to and/or used by another unit. For example, such information may be transmitted to a processor of an autonomous driving device, such as, but not limited to, a vehicle, drone, or the like, in which a LiDAR device may be employed. In addition, such information may be utilized in other electronic devices such as, but not limited to, a smartphone, a mobile phone, a personal digital assistant (PDA), a laptop, a personal computer (PC), a wearable device, other mobile or non-mobile computing devices, or the like.

The LiDAR device, according to an embodiment, may include a structure of a pixel 120 of a focal plane array system 100, according to various embodiments described with reference to FIGS. 2 to 8. The LiDAR device, according to an embodiment, may be applied to various electronic devices such as, but not limited to, a smartphone, a mobile phone, a PDA, a laptop, a PC, a wearable device, or the like. For example, a smartphone may extract depth information of subjects in an image, adjust out-of-focus of an image, and/or automatically identify subjects in an image using the LiDAR device, according to an embodiment, as an object 3D sensor. In addition, the LiDAR device, according to an embodiment, may be applied to a vehicle. The vehicle may include a plurality of LiDAR devices positioned at various locations. The vehicle may provide a driver with various information about the inside and/or surroundings of the vehicle using the LiDAR devices, and may provide information necessary for autonomous driving by automatically recognizing things or people in an image.

Referring to FIG. 2, the structure of the pixel 120 of the focal plane array system 100 may include a transmitter 300 including a laser element that may emit a signal light beam, a receiver 400 including a photodetector that may receive a light beam, and an interference light beam controller 200. The interference light beam controller 200 may include a splitter 220 arranged on an emission path of a signal light beam Ls to split a portion of the signal light beam Ls into an interference light beam Lo, a receiving coupler 230 arranged on a reception path of the signal light beam Ls reflected from the target object 10, and a waveguide 210 that may transmit (e.g., transport) the interference light beam Lo split by the splitter 220 to the receiving coupler 230.

The signal light beam Ls may be emitted from the transmitter 300 in a first direction (e.g., in a z-axis direction). The splitter 220 may be provided to split a portion of the signal light beam Ls incident from the transmitter 300 into the interference light beam Lo and may allow most (e.g., a portion) of the signal light beam Ls to pass through. The interference light beam Lo split from the splitter 220 may travel along the waveguide 210 in a second direction (e.g., y-direction). The signal light beam Ls passing through the splitter 220 may be fired toward the target object 10 in the form of a free space beam as a transmission signal light beam.

The first direction (e.g., z-axis direction) in which the signal light beam Ls emitted from the transmitter 300 travels to the splitter 220 may be different from the second direction (e.g., y-direction) in which the interference light beam Lo travels to the waveguide 210. For example, the transmitter 300 may be provided to emit the signal light beam Ls in the first direction (e.g., z-axis direction). The signal light beam Ls emitted from the transmitter 300 may be incident on the splitter 220 of the interference light beam controller 200 without via the waveguide 210.

The signal light beam Lr reflected from the target object 10 may be received by the receiver 400 as a free space beam and as a reception signal light beam via the receiving coupler 230. The receiving coupler 230 may be provided to pass the signal light beam Lr reflected from the target object 10 through the receiving coupler 230 to propagate to the receiver 400 and to couple the interference light beam Lo that has propagated through a waveguide 210 to propagate to the receiver 400 together with the signal light beam Lr.

The splitter 220, the receiving coupler 230, and the waveguide 210 may be provided on, for example, a substrate 201, thereby being arranged in plane. The first direction (e.g., the z-axis direction) may not be in a plane, and the second direction (e.g., the y-direction) may be in the plane. The first direction may be, for example, perpendicular to the second direction. In one or more embodiments, the interference light beam controller 200 may be positioned above the transmitter 300 and the receiver 400 in the z-axis direction (e.g., a vertical direction of the LiDAR device). As a result, the light propagates through free space (e.g., air gaps) between the interference light beam controller 200 and both the transmitter 300 and the receiver 400. This free-space optical path may result in lower light loss compared to a waveguide-based transmission path, due to reduced propagation and coupling losses.

In such a manner, according to the focal plane array system 100, according to an embodiment, only the interference light beam Lo may propagate through the waveguide 210 and the optical element in a plane, and thus, light loss may be minimized.

The substrate 201 on which the splitter 220, the receiving coupler 230, and the waveguide 210 are provided may be a substrate made of a material transparent to a wavelength of light emitted from the laser element 310, such as, but not limited to, a glass substrate and/or a silicon (Si) substrate, thereby minimizing light absorption by the substrate 201. The splitter 220, the receiving coupler 230, and the waveguide 210 may use high-refractive optical materials such as, but not limited to, silicon nitride (SiN), titanium oxide (TiO₂), and silicon (Si). For example, the splitter 220, the receiving coupler 230, and the waveguide 210 may be formed by depositing high-refractive optical materials such as, but not limited to, silicon nitride (SiN), titanium oxide (TiO₂), and silicon (Si) on a glass substrate to form a layer and etching the layer. The coupling strength of the splitter 220 and the receiving coupler 230 may be adjusted, for example, through a depth of a grating and a difference in refractive index with a surrounding material. In order to adjust the coupling strength, an optical material such as, but not limited to, silicon oxide (SiO₂) may be additionally deposited on the splitter 220 and the receiving coupler 230. As another example, the substrate 201 may be a glass substrate, and the splitter 220, the receiving coupler 230, and the waveguide 210 may be formed within the glass substrate through an ion exchange method. However, embodiments of the present disclosure may not be limited thereto.

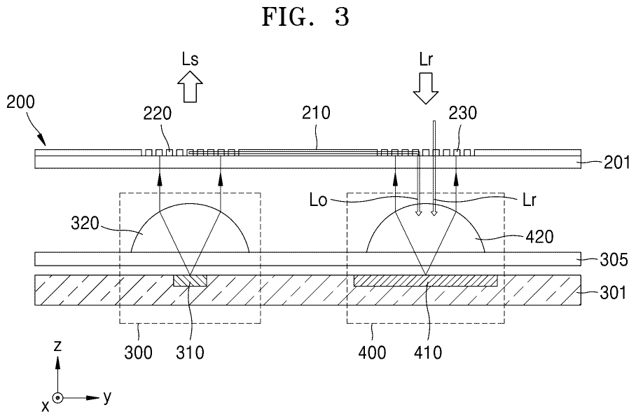

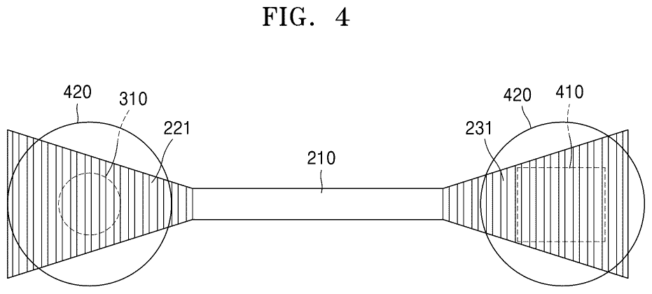

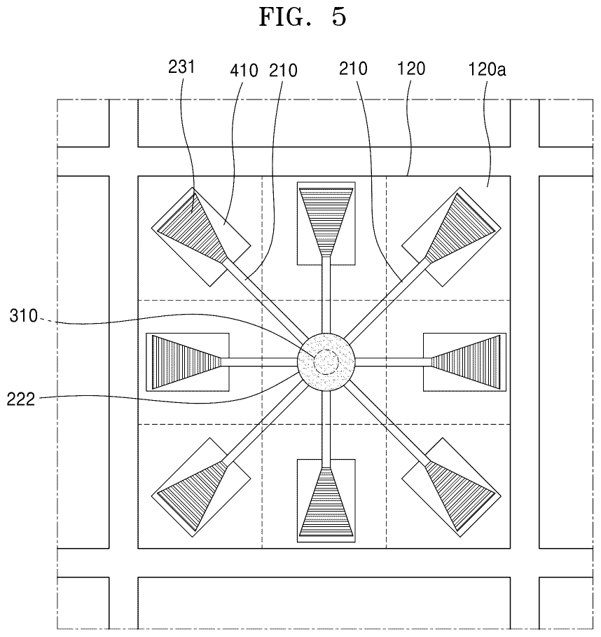

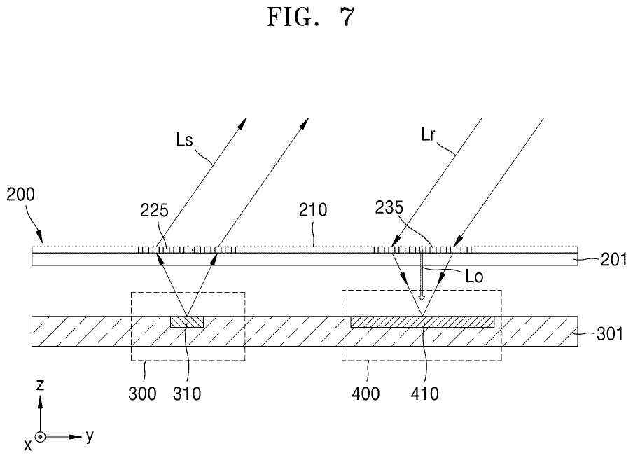

The splitter 220 may be, for example, at least one of a transmitting grating coupler (e.g., a transmitting grating coupler 221 of FIG. 4), an omnidirectional coupler (e.g., an omnidirectional coupler 222 of FIG. 5), or a meta surface lens (e.g., a meta surface lens 225 of FIG. 7), and the receiving coupler 230 may be, for example, at least one of a receiving grating coupler (e.g., a receiving grating coupler 231 FIG. 4) or a meta surface lens 235 (e.g., a meta surface lens 235 of FIG. 7). For example, the meta surface lens 235 or 225 may be a flat lens that has nanostructures configured to manipulate or focus light. The splitter 220, the waveguide 210, and the receiving coupler 230 may be formed to be connected to each other in the same plane (e.g., at the same level with respect to a first substrate 301 or a second substrate 305 shown in FIG. 3, while the transmitter 300 and the receiver 400 may be positioned at a different level from that of the splitter 220, the waveguide 210, and the receiving coupler 230). For example, the splitter 220 may be optically connected to one end of the waveguide 210, and the receiving coupler 230 may be optically connected to the other end of the waveguide 210.

FIG. 3 is a diagram schematically illustrating an example of the structure of the pixel 120 of the focal plane array system 100, according to the embodiment of FIG. 2.

Referring to FIG. 3, the structure of the pixel 120 of the focal plane array system 100 may include the transmitter 300 including a laser element 310 that may emit a signal light beam Ls, the receiver 400 including a photodetector 410 that may receive the light beam, and the interference light beam controller 200.

The transmitter 300 may include, for example, the laser element 310 and a first micro lens 320 that may condense a signal light beam Ls diverging from the laser element 310. The receiver 400 may include, for example, the photodetector 410 and a second micro lens 420 that may converge the interference light beam Lo together with the signal light beam Lr reflected from the target object 10 onto the photodetector 410.

As shown in FIG. 3, each pixel 120 of the focal plane array system 100 may include the laser element 310, the photodetector 410, the first micro lens 320 corresponding to the laser element 310, and the second micro lens 420 corresponding to the photodetector 410. The laser element 310 and the photodetector 410 may be provided in a first substrate 301, and the first micro lens 320 and the second micro lens 420 may be provided in a second substrate 305 that may be different from the first substrate 301.

The first substrate 301 may be a photonic integrated circuit (PIC) substrate 110 (as described in FIG. 1), for example, a silicon photonic integrated circuit substrate. A circuit for driving the laser element 310 of each pixel 120, a light receiver-circuit to detect an interference signal received by the photodetector 410 of each pixel 120, or the like may be integrated into the first substrate 301. The LiDAR device including the focal plane array system 100, according to an embodiment, may measure a pulse frequency of the interference signal in the light receiver-circuit to calculate a distance and velocity of the target object 10. A calculation of the distance and velocity of the target object 10 may be performed in the processor 500. The processor 500 of the LiDAR device may analyze the pulsation frequency in up-chirp section and/or down-chirp section to calculate the distance and the velocity relative to the target object 10. For example, an analog electrical signal may be binarized through an analog-to-digital converter (ADC), and converted into frequency domain information through a fast Fourier transform (FFT) in a digital operation part, and may be converted into a point cloud representing a depth or velocity map, which may be and/or may include frequency domain information at each pixel 120, and may be utilized in upper-level applications such as, but not limited to, autonomous driving through an analysis algorithm including image processing.

The laser element 310 may be provided to emit a signal light beam Ls in the first direction (e.g., in the z-axis direction) with respect to the first substrate 301, and the signal light beam Ls may be and/or may include a coherent light beam. The laser element 310 may include, for example, a vertical-cavity surface emitting laser (VCSEL) element, and the VCSEL element may be formed on the first substrate 301 through a semiconductor manufacturing process and/or may be manufactured separately and integrated on the first substrate 301. As another example, the laser element 310 may include an edge emitting laser element, and the edge emitting laser may be formed on the first substrate 301 through a semiconductor manufacturing process, or may be manufactured separately and integrated on the first substrate 301, and may be provided to emit a signal light beam Ls in the first direction (e.g., in the z-axis direction). That is, when the laser element 310 includes an edge emitting laser element, a reflective member may be further provided to direct the laser light beam emitted from the edge emitting laser element in the first direction (e.g., in the z-axis direction). As another example, the laser element 310 may include a VCSEL distributed feedback laser. Here, the laser element 310 is described as being provided as a light source of the transmitter 300, but is not limited thereto. For example, as long as the signal light beam Lr reflected from the target object 10 and the interference light beam Lo have coherency that may generate an interference signal by interfering, the light source of the transmitter 300 may not be limited to the laser element 310. For example, the transmitter 300 may include a light-emitting diode (LED), a super luminescent diode (SLD), or the like, which are provided to emit a light beam having coherence as a light source.

The transmitter 300 may be controlled to transmit a signal light beam Ls of frequency-modulated continuous wave (FMCW) from the laser element 310, whereby the LiDAR device including the focal plane array system 100, according to an embodiment, may be implemented as an FMCW LiDAR device.

On the second substrate 305, the first micro lens 320 and the second micro lens 420 may be arranged to correspond to the laser element 310 and the photodetector 410 of each pixel 120. The second substrate 305 may include a transparent material with respect to the wavelength of light emitted from the laser element 310. The first substrate 301 and the second substrate 305 may be combined. Although in FIG. 3, the second substrate 305 is illustrated as being spaced apart from the first substrate 301, embodiments of the present disclosure are not limited thereto. For example, a support structure or support layer may be formed between the first substrate 301 and the second substrate 305, and the second substrate 305 may be fixed with respect to the first substrate 301.

FIG. 4 is a plan view of a structure of a pixel 120 of an interference light beam controller 200, according to an embodiment, and a focal plane array system 100 including the same, according to an embodiment. Compared to FIG. 3, FIG. 4 shows an example in which the splitter 220 of the interference light beam controller 200 includes a transmitting grating coupler 221, and the receiving coupler 230 of the interference light beam controller 200 includes a receiving grating coupler 231.

As illustrated in FIG. 4, the transmitting grating coupler 221 may have a tapered shape with a width narrowing toward the waveguide 210, and the receiving grating coupler 231 may have a tapered shape with a width widening away from the waveguide 210 (e.g., a tapered shape having a width narrowing toward the waveguide 210. The sizes (e.g., areas) of the transmitting grating coupler 221 and the receiving grating coupler 231 may be the same or different each other. FIG. 4 shows an example where the sizes of the transmitting grating coupler 221 and the receiving grating coupler 231 are the same each other. However, embodiments of the present disclosure are not limited thereto. For example, the size of the transmitting grating coupler 221 may be less than the size of the receiving grating coupler 231. Additionally, the size of the transmitting grating coupler 221 may be greater than the size of the receiving grating coupler 231. The size of the transmitting grating coupler 221 may be determined in consideration of beam size and intensity of the signal light beam Ls incident from the transmitter 300. The size of the receiving grating coupler 231 may be determined in consideration of beam size of the signal light beam Lr received by the photodetector 410 of the receiver 400.

The transmitting grating coupler 221 may be provided to couple, for example, a portion of the signal light beam Ls incident from the transmitter 300 and propagate the signal light beam Ls as an interference light beam Lo to the waveguide 210. The transmitting grating coupler 221 may be provided to couple the signal light beam Ls with a weak intensity, for example, an intensity of a few percent (%) or less, and thus branch a small portion of the signal light beam Ls into an interference light beam Lo. The transmitting grating coupler 221 may be provided to pass most of the signal light beam Ls and couple some light quantity, for example, a light quantity of a few % or less, to convert into an in-plane beam. The signal light beam Ls passing through the transmitting grating coupler 221 may correspond to a 0^{th}-order diffraction light beam and may be emitted toward the target object 10 in the form of a free-space transmission light beam. The interference light beam Lo coupled by the transmitting grating coupler 221 and converted into an in-plane beam may correspond to, for example, a first-order diffraction light beam. The interference light beam Lo obtained by converting proceeding direction into an in-plane may correspond to a local oscillator LO light beam. The interference light beam Lo may travel through the waveguide 210 and reach the receiving grating coupler 231.

The receiving grating coupler 231 may be provided to couple the interference light beam Lo that has traveled through the waveguide 210 to convert into an out-of-plane beam, and thus, may transmit the out-of-plane beam to the receiver 400. Additionally, the receiving grating coupler 231 may be provided to pass most of the signal light beam Lr that may be incident after being reflected from the target object 10. For example, the receiving grating coupler 231, similar to the transmitting grating coupler 221, may be configured to pass most of the signal light beam Lr and couple the interference light beam Lo with a weak intensity (e.g., an intensity of a few % or less). Thereby, the interference light beam Lo may proceed to the receiver 400 together with the signal light beam Lr by the receiving grating coupler 231. The signal light beam Lr passing through the receiving grating coupler 231 may correspond to a 0^{th}-order diffraction light beam and may be a receiving signal light beam received by the photodetector 410 of the receiver 400. The interference light beam Lo coupled by the receiving grating coupler 231 and converted into an out-of-plane beam may correspond to, for example, a first-order diffraction light beam. The signal light beam Lr incident on the photodetector 410 of a receiver 400 may cause interference with the interference light beam Lo, and a pulsation frequency of the interference signal may be measured in the light receiver-circuit to calculate a distance and velocity of the target object 10.

Transmission ratios of the signal light beams Ls and Lr and coupling ratios of the interference light beams Lo of the transmitting grating coupler 221 and the receiving grating coupler 231 may be determined within a range in which interference may occur between the interference light beam Lo and the signal light beam Lr proceeding to the receiver 400, thereby generating an interference signal. The interference light beam Lo coupled by the transmitting grating coupler 221 to be converted into an in-plane beam and proceeding through the waveguide 210 and the interference light beam Lo coupled by the receiving grating coupler 231 to be converted into an out-of-plane beam and proceeding to the receiver 400 may have different light intensities, but they are expressed without distinction here.

The transmitting grating coupler 221, the receiving grating coupler 231, and the waveguide 210 may use at least one of high-refractive optical materials such as, but not limited to, silicon nitride (SiN), titanium oxide (TiO₂), and silicon (Si). For example, the transmitting grating coupler 221, the receiving grating coupler 231, and the waveguide 210 may be formed by depositing and etching the at least one of the high refractive index optical materials such as, but not limited to, silicon nitride (SiN), titanium oxide (TiO₂), and silicon (Si) on a glass substrate. Coupling strengths of the transmitting grating coupler 221 and the receiving grating coupler 231 may be adjusted, for example, through a depth of a grating and a difference in refractive index with a surrounding material. In order to adjust the coupling strength, an optical material such as, but not limited to, silicon oxide (SiO₂) may be additionally deposited on the transmitting grating coupler 221 and/or the receiving grating coupler 231.

FIG. 4 shows an example in which each pixel 120 of the focal plane array system 100 is formed as a single pixel structure. However, embodiments of the present disclosure are not limited thereto. For example, as shown in FIG. 5, each pixel 120 of the focal plane array system 100 may be provided to include one laser element 310 and a plurality of photodetectors 410, thereby including a plurality of sub-pixels 120a.

FIG. 5 is a plan view of a structure of a pixel 120 of an interference light beam controller 200 and a focal plane array system 100 including the same, according to an embodiment. Compared to FIGS. 3 and 4, the interference light beam controller 200 of FIG. 5 may be provided with a structure including an omnidirectional coupler 222 as the splitter 220, a plurality of waveguides 210 arranged radially, and a plurality of receiving grating couplers 231.

Referring to FIG. 5, the splitter 220 of the interference light beam controller 200 may include the omnidirectional coupler 222. A plurality of waveguides 210 may be connected to the omnidirectional coupler 222 and may be arranged radially. The interference light beam controller 200 may include a plurality of receiving grating couplers 231, and each receiving grating coupler 231 may be connected to each of the plurality of waveguides 210 arranged radially. That is, the receiving coupler 230 of the interference light beam controller 200 may include the plurality of receiving grating couplers 231 connected to each of the plurality of waveguides 210.

When the interference light beam controller 200 has the structure illustrated in FIG. 5, in the structure of the pixel 120 of the focal plane array system 100, according to an embodiment, the transmitter 300 may include a laser element 310 and a first micro lens 320, and the receiver 400 may include a plurality of photodetectors 410 and a plurality of second micro lenses 420 corresponding to each photodetector 410. That is, the receiver 400 may include the photodetector 410 and the second micro lens 420 in each sub-pixel 120a.

In such a manner, the structure of each pixel 120 may be configured to include a plurality of sub-pixel 120a arrays, thereby potentially improving the image resolution of a device including the focal plane array system 100, according to an embodiment, such as, but not limited to, a LiDAR device.

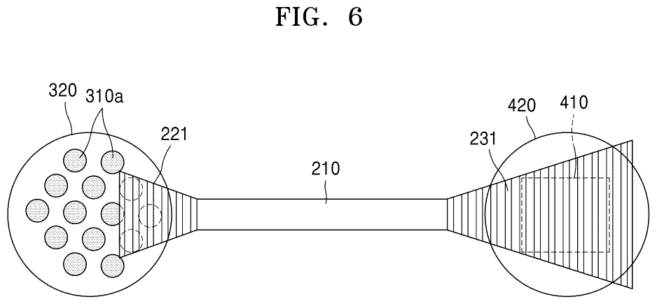

FIG. 6 is a plan view of a structure of a pixel 120 of an interference light beam controller 200 and a focal plane array system 100 including the same, according to an embodiment. Compared to FIGS. 3 and 4, FIG. 6 shows an example in which the laser element 310 includes a plurality of coherent laser element arrays 310a, and the transmitting grating coupler 221 is provided to overlap a signal light beam Ls emitted from some laser elements among the plurality of laser element arrays 310a. To this end, for example, when the first micro lens 320 and the second micro lens 420 are formed to have the same size, the transmitting grating coupler 221 may be formed to have a less size than the receiving grating coupler 231. Here, the plurality of coherent laser element arrays 310a may be a VCSEL type.

FIG. 7 is a diagram schematically illustrating a structure of a pixel 120 of a focal plane array system 100, according to an embodiment. FIG. 7 may differ from FIG. 3 in that the first micro lens 320 and the second micro lens 420 may be excluded.

In an embodiment, the interference light beam controller 200 may include a first meta surface lens 225 as the splitter 220 and a second meta surface lens 235 as the receiving coupler 230, the transmitter 300 may include the laser element 310, and the receiver 400 may include the photodetector 410.

The laser element 310 and the photodetector 410 may be provided on the first substrate 301. The first meta surface lens 225, the waveguide 210, and the second meta surface lens 235 of the interference light beam controller 200 may be formed to be interconnected on the substrate 201. The first meta surface lens 225 may be optically connected to one end of the waveguide 210, and the second meta surface lens 235 may be optically connected to the other end of the waveguide 210.

The first meta surface lens 225 may be provided to condense a signal light beam Ls emitted from the laser element 310, and couple a portion of the signal light beam Ls to proceed to the waveguide 210 as an interference light beam Lo. Therefore, the first micro lens 320 shown in FIG. 3 may be omitted. Most of the signal light beam Ls may be condensed by the first meta surface lens 225 and emitted toward the target object 10 in the form of a free space beam as a transmission signal light beam. In an embodiment, the first meta surface lens 225 may not maximize a coupling ratio, but may be provided so that a portion of the signal light beam Ls may be coupled into the waveguide 210 as the interference light beam Lo by light scattering. The first meta surface lens 225 may be provided to additionally function as an optical deflector that may deflect the signal light beam Ls. That is, the first meta surface lens 225 may be provided to converge the signal light beam Ls while simultaneously proceeding with a predetermined inclination angle.

The second meta surface lens 235 may be provided to converge the signal light beam Lr reflected from the target object 10 and couple the interference light beam Lo propagated through the waveguide 210, thereby converging the interference light beam Lo on the photodetector 410 together with the signal light beam Lr reflected from the target object 10. Therefore, in an embodiment, the second micro lens 420 shown in FIG. 3 may be omitted. In the second meta surface lens 235, a portion of the interference light beam Lo that has propagated through the waveguide 210 may be scattered and directed to the receiver 400.

The intensity of the interference light beam Lo that reaches the photodetector 410 of the receiver 400 may be less than a few percent of an output power of the laser element 310, but may have sufficient intensity due to a relatively high laser power.

The first meta surface lens 225 and the second meta surface lens 235 may be formed by depositing a high refractive material on the substrate 201 and etching the high refractive material into a nano pillar pattern. In some embodiments, shapes, widths, and heights of nano pillars may be changed to have a necessary phase delay value according to a location and/or design constraints.

In an embodiment, each pixel 120 may be and/or may include a single pixel structure including the laser element 310 and the photodetector 410, and the structure of the interference light beam controller 200 may be formed into a planar structure as described with reference to FIG. 4. For example, the first meta surface lens 225 may have a tapered shape with a width narrowing toward the waveguide 210, and the second meta surface lens 235 may have a tapered shape with a width widening away from the waveguide 210 (e.g., a tapered shape having a width narrowing toward the waveguide 210).

As another example, as described with reference to FIG. 5, each pixel 120 may be provided to include the laser element 310 and the plurality of photodetectors 410, thereby including the plurality of sub-pixels 120a. That is, the structure of the interference light beam controller 200 may be formed as a planar structure as described with reference to FIG. 5. The first meta surface lens 225 may include an omnidirectional meta surface lens. A plurality of waveguides 210 may be connected to the omnidirectional meta surface lens and may be arranged radially. The second meta surface lens 235 may be arranged in multiple numbers and connected to each of the plurality of waveguides 210 arranged radially. That is, the interference light beam controller 200 may include an omnidirectional meta surface lens as the first meta surface lens 225 and may include a plurality of second meta surface lenses 235 connected to each of the plurality of waveguides 210. When the interference light beam controller 200 in FIG. 7 has a planar structure as described with reference to FIG. 5, in the structure of the pixel 120 of the focal plane array system 100, according to an embodiment, the transmitter 300 may include the laser element 310, and the receiver 400 may include a plurality of photodetectors 410. Accordingly, the receiver 400 may include one photodetector 410 in each sub-pixel 120a.

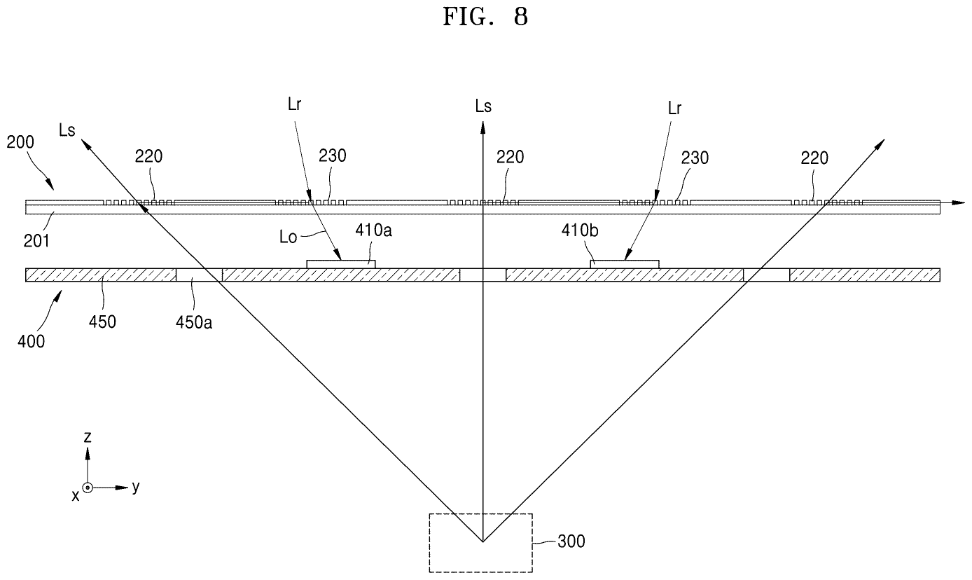

Although the above description describes and illustrates that the laser element 310 and the photodetector 410 may arranged in the first substrate 301, embodiments of the present disclosure are not limited thereto. For example, as illustrated in FIG. 8, a structure of a pixel 120 of a focal plane array system 100, according to an embodiment, may be provided so that a substrate in which the laser element 310 is arranged may be different from a substrate in which the photodetector 410 is arranged.

FIG. 8 is a diagram schematically illustrating a focal plane array system 100, according to an embodiment.

Referring to FIG. 8, the focal plane array system 100, according to an embodiment, may be provided to drive a plurality of pixels 120 by a signal light beam Ls sequentially scanned by a transmitter 300.

In an embodiment, an interference light beam controller 200 may have a structure in which a plurality of splitters 220 are spaced apart, a plurality of receiving couplers 230 are arranged between the plurality of splitters 220, and a plurality of waveguides 210 connecting each splitter 220 to each receiving coupler 230 are arranged in a substrate 201. The transmitter 300 may include a beam scanner and may sequentially irradiate a signal light beam Ls emitted from one laser element 310 toward an opening 450a of each pixel, thereby scanning the signal light beam Ls to sequentially input into the plurality of splitters 220. The beam scanner may be and/or may include a micro-electronic-mechanical system (MEMS)-based scanner, a mechanical scanner, or the like. The receiver 400 may include a plurality of photodetectors 410 arranged in a substrate 450 corresponding to the plurality of receiving couplers 230. In the substrate 450, a plurality of openings 450a may be provided to correspond to the splitters 220 of the interference light beam controller 200 so that the opening 450a of each pixel may allow the signal light beam Ls to pass therethrough. The opening 450a may be a hole or may be formed of a material transparent to a wavelength of the signal light beam Ls. Each photodetector 410 may detect an interference signal of the signal light beam Lr reflected from the target object 10 and passed through the receiving coupler 230 and the interference light beam Lo that is split from each splitter 220, travels along the waveguide 210, coupled by an adjacent receiving coupler 230 and proceeds toward the receiver 400. FIG. 8 shows an example in which the plurality of splitters 220 are provided to split an incident signal light beam Ls and proceed a split signal light beam to the waveguide 210 located at the right side. However, embodiments of the present disclosure are not limited thereto. For example, each of the plurality of splitters 220 may be provided to split the incident signal light beam Ls and proceed a split signal light beam to the waveguide 210 located at the left side.

In an embodiment, each splitter 220 may be optically connected to one end of the waveguide 210, and each receiving coupler 230 may be optically connected to the other end of the waveguide 210. The splitter 220 may be, for example, at least one of the transmitting grating coupler 221, the omnidirectional coupler 222, or the meta surface lens 225, and the receiving coupler 230 may be, for example, at least one of the receiving grating coupler 231 or the meta surface lens 235. In addition, each pixel 120 may include the splitter 220, at least one waveguide 210, and at least one receiving coupler 230. That is, each pixel 120 may have a single pixel structure as described with reference to FIGS. 4 and 6, and/or a structure including a plurality of sub-pixels as described with reference to FIG. 5.

For example, the splitter 220 may include an omnidirectional coupler or an omnidirectional meta surface lens, and in each pixel 120, a plurality of waveguides 210 may be arranged radially, and a plurality of receiving couplers 230 may be connected to each of the plurality of waveguides 210. In addition, the receiver 400 in each pixel 120 may include a plurality of photodetectors 410. Therefore, the receiver 400 may include the photodetector 410 in each sub-pixel 120a.

The focal plane array system 100, according to an embodiment, described with reference to FIG. 8 may drive a plurality of pixels with a single laser element, and thus, the number of laser elements required for two-dimensional (2D) driving may be reduced.

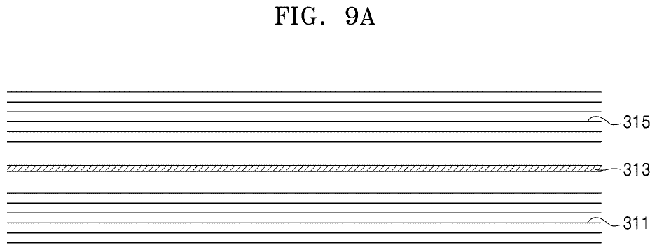

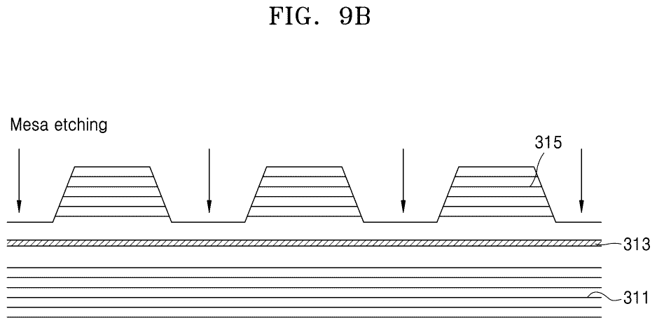

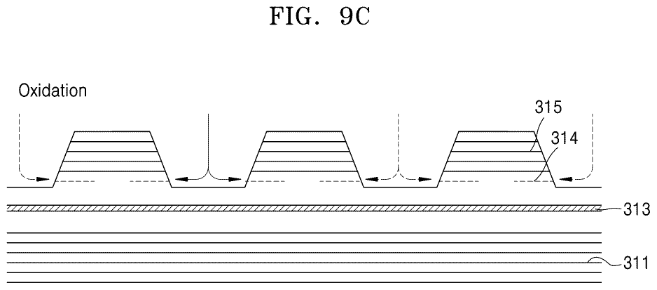

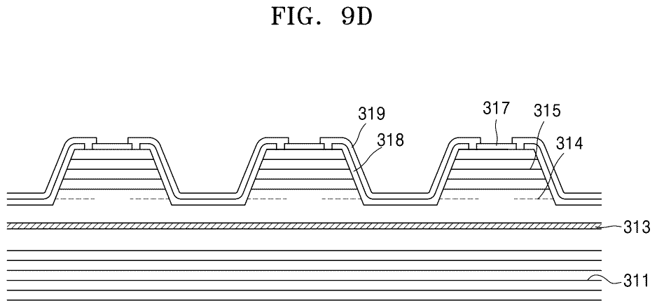

FIGS. 9A to 9D are diagrams showing an example of a method of manufacturing the laser element 310 including the coherent plurality of laser element arrays 310a, according to an embodiment. FIGS. 9A to 9D show a method of manufacturing the coherent plurality of laser element arrays 310a of a VCSEL type.

Referring to FIG. 9A, a first reflector layer 311, an active layer 313, and a second reflector layer 315 may be sequentially stacked on a substrate. The first reflector layer 311 and the second reflector layer 315 may be and/or may include distributed Bragg reflector (DBR) layers. A first cavity layer and a second cavity layer may respectively be formed between the first reflector layer 311 and the active layer 313 and/or between the active layer 313 and the second reflector layer 315.

Referring to FIG. 9B, the second cavity layer may be etched to a certain thickness to form a plurality of mesa structure arrays.

Referring to FIG. 9C, a current confinement layer 314 may be formed by oxidizing from a sidewall of each mesa structure to a certain depth by an oxidation process. When current is applied, carriers may move through a center region of the un-oxidized current confinement layer 314 so that a light-emitting region may be limited. Each mesa structure in which the current confinement layer 314 is formed may constitute a VCSEL element.

As shown in FIG. 9D, a passivation layer 318 may be formed to cover the sidewall of each mesa structure and between the mesa structures, and a metal contact layer 319 may be formed to electrically connect the plurality of mesa structures to each other and form a window 317 through which laser light generated from each mesa structure is emitted. Thereby, because the plurality of mesa structures are electrically connected to each other, the coherent plurality of laser element arrays 310a of a VCSEL type may be formed.

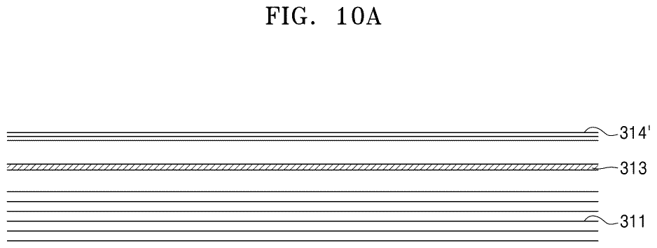

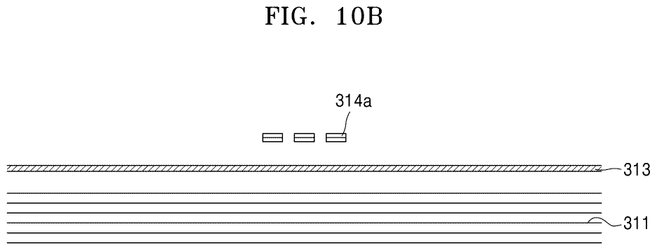

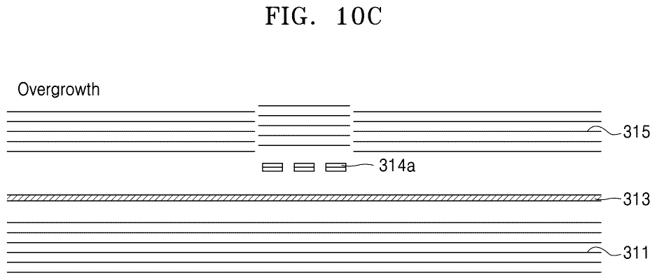

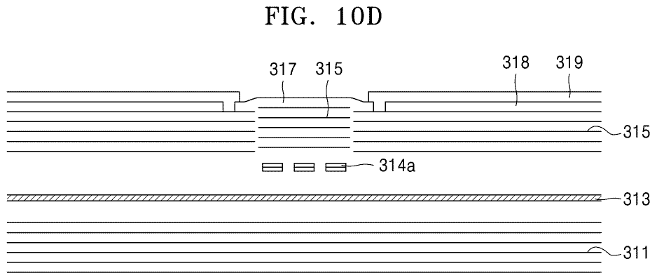

FIGS. 10A to 10D show another example of a method of manufacturing the laser element 310 including the coherent plurality of laser element arrays 310a, according to an embodiment. FIGS. 10A to 10D illustrate a method of manufacturing the coherent multiple laser element array 310a of a VCSEL type by forming a tunnel junction layer as a current confinement layer.

Referring to FIG. 10A, a first reflector layer 311, an active layer 313, and a tunnel junction layer 314′ may be sequentially stacked on a substrate. The first reflector layer 311 and a second reflector layer 315 formed in operation of FIG. 10C may be and/or may include a DBR layer. A first cavity layer and a second cavity layer may respectively be formed between the first reflector layer 311 and the active layer 313 and between the active layer 313 and the second reflector layer 315.

For example, a portion of the thickness of the second cavity layer may be formed on the active layer 313 and then the tunnel junction layer 314′ may be formed. The remaining thickness of the second cavity layer may be formed after patterning the tunnel junction layer 314′ to confine a region through which current flows, as shown in FIG. 10C.

Referring to FIG. 10B, the tunnel junction layer 314′ may be patterned by aperture patterning, thereby forming a plurality of discontinuous tunnel junction layer regions 314a.

Referring to FIG. 10C, the remaining thickness of the second cavity layer may be formed to cover the plurality of discontinuous tunnel junction layer regions 314a, and the second reflector layer 315 may be formed. A region where carriers move may be confined by the plurality of discontinuous tunnel junction layer regions 314a, and thus a plurality of discontinuous light-emitting regions may be limited.

As shown in FIG. 10D, a passivation layer 318 may be formed to cover a region other than the plurality of discontinuous light-emitting regions, and a metal contact layer 319 may be formed to form a window 317 through which laser light generated in the plurality of discontinuous light-emitting regions is emitted. Thereby, because the plurality of discontinuous light-emitting regions are electrically connected to each other, the coherent plurality of laser element arrays 310a of a VCSEL type may be formed. The coherent plurality of laser element arrays 310a formed in this manner may form a coherent VCSEL array having high light output power through optical mutual coupling.

As described above, the focal plane array system 100, according to an embodiment, may have various pixel structures, and the transmitter 300 may be controlled to emit a signal light beam Ls of frequency-modulated continuous wave (FMCW) from the laser element 310, and thus, the LiDAR device including the focal plane array system 100, according to an embodiment, may be implemented as an FMCW LiDAR device.

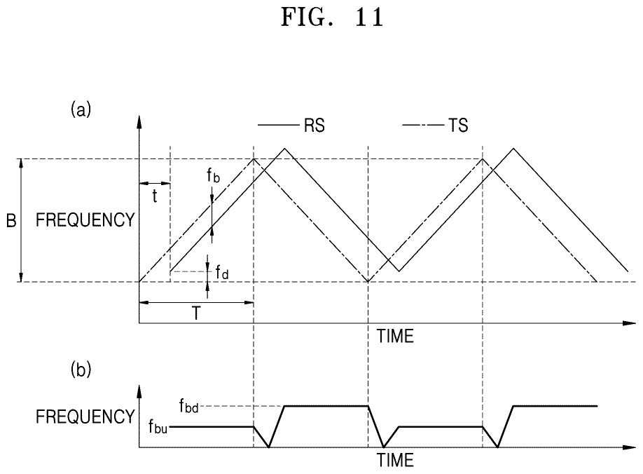

FIG. 11 is a diagram showing a transmission signal TS and a reception signal RS with varying frequency, and beat signals f_{bu} and f_{bd} corresponding thereto.

Referring to FIG. 11, the transmission signal TS (e.g., the signal light beam Ls) used in a LiDAR device using the FMCW driving manner, may be a frequency modulated continuous wave having a frequency that may change linearly over time. As another example, the transmission signal TS (e.g., the signal light beam Ls) used in a LiDAR device using the FMCW driving manner, may be a frequency-modulated continuous wave having a frequency that may change nonlinearly over time. Although the present disclosure describes an example in which the transmission signal TS (e.g., the signal light beam Ls) has a frequency that changes linearly over time, embodiments of the present disclosure are not limited thereto.

The laser element 310 or 310a of the transmitter 300 may be driven by the transmission signal TS as shown in FIG. 11. Thereby, the laser element 310 or 310a may emit the signal light beam Ls of the frequency-modulated continuous wave. As the interference light beam Lo may have the same frequency characteristics as the signal light beam Ls, a signal that detects the interference light beam Lo may correspond to the transmission signal TS. The reception signal RS that detects the signal light beam Lr reflected from the target object 10 may, similarly as illustrated in FIG. 11, be in the form of a frequency-modulated continuous wave having varying frequency. Hereinafter, for convenience, the signal light beam Ls and the interference light beam Lo may be expressed as the transmission signal TS, and the signal light beam Lr may be expressed as the reception signal RS.

In the graph (a) of FIG. 11, the transmission signal TS is depicted as a dashed line, and the reception signal RS is depicted as a solid line. B may represent a modulation bandwidth, and T may represent a modulation period. The modulation bandwidth may refer to a range in which the frequency of the transmission signal TS varies, and may refer to a difference between the maximum frequency and the minimum frequency of the transmission signal TS. In addition, the modulation period may denote a time it takes to modulate the frequency of the transmission signal TS, and may refer to a time it takes for the transmission signal TS to complete one frequency sweep (e.g., up-chirp or down-chirp).

When the frequency of the transmission signal TS irradiated from the LiDAR device toward a target object, for example, increases and/or decreases linearly, a frequency of the reception signal RS reflected from the target object and returned to the LiDAR device may also, for example, increase and/or decrease linearly.

As shown in FIG. 11, there may be a delay time t between a time when the transmission signal TS is transmitted from the LiDAR device and a time when the reception signal RS is detected by the LiDAR device. Therefore, a constant frequency difference f_{b} may exist between the transmission signal TS and the reception signal RS. In addition, a frequency change corresponding to the Doppler frequency f_{d} of the transmission signal TS and the reception signal RS may occur due to changes in a relative distance and a velocity between the LiDAR device and the target object.

Accordingly, a beat signal generated by an interference phenomenon of the transmission signal TS and the reception signal RS may have, for example, a constant frequency. As used herein, the beat signal may refer to a signal generated by mixing the transmission signal TS and the reception signal RS, that is, an interference signal generated by interference between the interference light beam Lo and the signal light beam Lr reflected from the target object, and may refer to a signal having a beat frequency. For example, the beat signal may refer to a signal generated by mixing the transmission signal TS and the reception signal RS, and the beat frequency may refer to a frequency of the beat signal. The beat frequency may correspond to a frequency difference between the transmission signal TS and the reception signal RS.

Graph (b) of FIG. 11 illustrates an up-beat signal f_{bu} and a down-beat signal f_{bd} generated from the transmission signal TS and the reception signal RS. The up-beat signal f_{bu} may represent a beat frequency corresponding to an up-chirp, and the down-beat signal f_{bd} may represent a beat frequency corresponding to a down-chirp, and may be represented as equations similar Equations 1 and 2.

$${f}_{bu} = {f}_{b} - {f}_{d} \qquad [ Equation 1 ]$$

$${f}_{bd} = {f}_{b} + {f}_{d} \qquad [ Equation 2 ]$$

Referring to Equations 1 and, the Doppler frequency f_{d} may be proportional to a relative velocity v of a target object to the LiDAR device and inversely proportional to a wavelength λ of the transmission signal TS, as represented in an equation similar to Equation 3.

$${f}_{d} = \frac{2 v}{λ} \qquad [ Equation 3 ]$$

Accordingly, as in following Equations 4 and 5, a distance R between the LiDAR device and the target object may be proportional to an average of the up-beat signal f_{bu} and the down-beat signal f_{bd}, and a difference between the up-beat signal f_{bu} and the down-beat signal f_{bd} may be proportional to the relative velocity v between the LiDAR device and the target object. In Equation 4, a slope may represent a velocity at which a frequency is modulated.

$$R = \frac{c}{4 slope} ( {f}_{bd} + {f}_{bu} ) \qquad [ Equation 1 ]$$

$$v = \frac{λ}{4} ( {f}_{bd} - {f}_{bu} ) \qquad [ Equation 2 ]$$

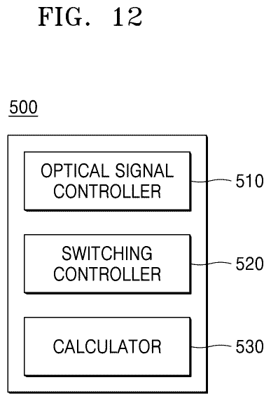

FIG. 12 is a block diagram of a processor 500 of a LiDAR device, according to an embodiment.

Referring to FIG. 12, the processor 500 may include a light signal controller 510, a switching controller 520, and a calculator 530.

The light signal controller 510 may control frequency modulation (or chirping) of the transmitter 300 and may include a feedback circuit such as, but not limited to, a phase-locked loop (PLL). The switching controller 520 may control switching of the structure of the pixel 120 of the focal plane array system 100. The calculator 530 may calculate at least one of a distance and a velocity of a target object based on a bit signal generated by an interference phenomenon between the transmission signal TS and the reception signal RS. In particular, the calculator 530 may calculate at least one of the distance and the velocity of the target object based on a bit signal.

In an embodiment, the light signal controller 510, the switching controller 520, and the calculator 530 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of the light signal controller 510, the switching controller 520, and the calculator 530. As another example, the processor 500 in combination with a memory may be used to execute one or more instructions to perform the functionality of the light signal controller 510, the switching controller 520, and the calculator 530.

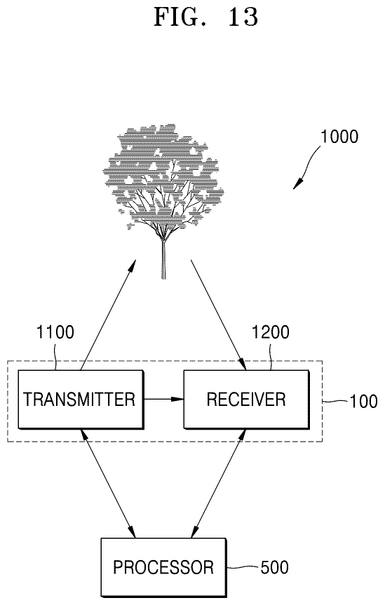

FIG. 13 is a schematic diagram of a LiDAR device 1000, according to an embodiment.

Referring to FIG. 13, the LiDAR device 1000 may include a focal plane array system 100 including a transmitter 1100 that may irradiate light to a target object, a receiver 1200 that may receive light reflected from the target object, and a processor 500 that may perform a calculation for obtaining information about the target object from the light received by the receiver 1200.

The focal plane array system 100, as described with reference to FIG. 1, may include the photonic integrated circuit (PIC) 110 and the plurality of pixels 120, and the plurality of pixels 120 may be two-dimensionally (2D) arranged in the photonic integrated circuit 110. In addition, the focal plane array system 100 may have a structure of the pixel 120, according to various embodiments described with reference to FIGS. 2 to 8, and may include an interference light beam controller 200, according to various embodiments. For example, the transmitter 1100 may have a structure including the laser element 310 and the first micro lens 320 as described with reference to FIG. 3, or a structure including the laser element 310 as described with reference to FIG. 7. As another example, the receiver 1200 may have a structure including the photodetector 410 and the second micro lens 420 as described with reference to FIG. 3, or a structure including the photodetector 410 as described with reference to FIG. 7. In addition, the structure of the pixel 120 of the focal plane array system 100 may be a single pixel structure as described with reference to FIG. 4 and FIG. 6, or a structure including a plurality of sub-pixels as described with reference to FIG. 5, or may be provided to form a plurality of pixels with respect to a signal light beam sequentially scanned by the transmitter 1100, as described with reference to FIG. 8.

The LiDAR device 1000 may selectively activate a plurality of pixels 120 of the focal plane array system 100 to scan one or more light beams in one or two dimensions, and perform a calculation for obtaining information about a target object in the processor 500. Each of the plurality of pixels 120 of the focal plane array system 100 may transmit a signal light beam Ls, split a portion of the signal light beam Ls into an interference light beam Lo, and receive a signal light beam Lr reflected from the target object and the interference light beam Lo to generate an interference signal.

The focal plane array system 100 and the processor 500 may be implemented as separate devices or as one device.

The processor 500 may perform a calculation for obtaining information about the target object from a light received from the receiver 1200. In addition, the processor 500 may oversee the processing and control of the LiDAR device 1000. The processor 500 may acquire and process information about the target object. For example, the processor 500 may acquire and process two-dimensional (2D) or three-dimensional (3D) image information. The processor 500 may control overall driving of the transmitter 1100 and operating of the receiver 1200 in the focal plane array system 100. The processor 500 may also analyze a distance between the target object and the LiDAR device 1000, a shape of the target object, or the like, through numerical information provided by the receiver 1200.

A 3D image acquired by the processor 500 may be transmitted to another unit to be utilized. For example, such information may be transmitted to a processor of an autonomous driving device such as, but not limited to, a vehicle or drone in which the LiDAR device 1000 is employed. In addition, the information may also be utilized in a smartphone, a mobile phone, a PDA, a laptop, a PC, a wearable device, other mobile or non-mobile computing devices.

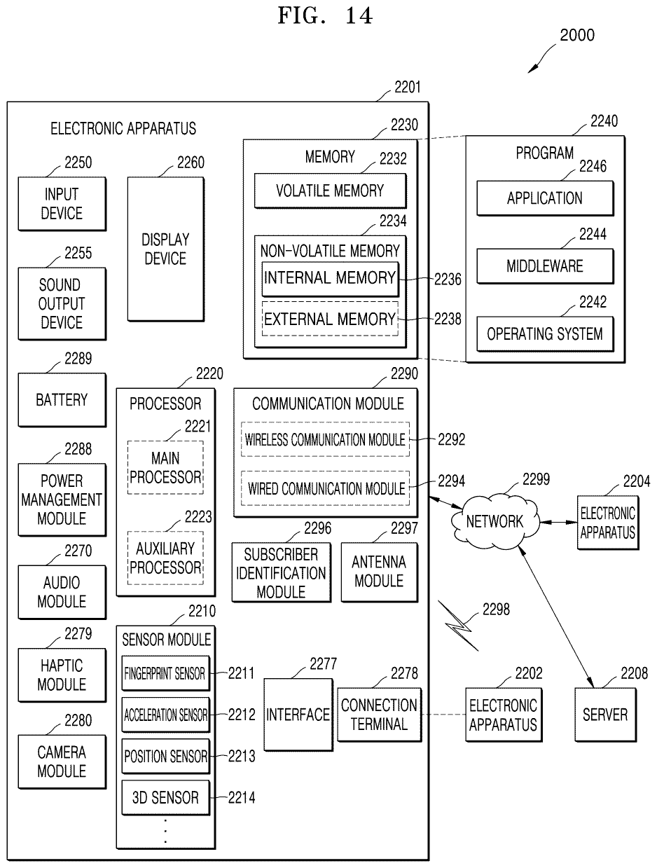

FIG. 14 is a block diagram showing a schematic configuration of an electronic apparatus including a LiDAR device, according to an embodiment.

Referring to FIG. 14, in a network environment 2000, an electronic apparatus 2201 may communicate with another electronic apparatus 2202 through a first network 2298 (e.g., a short-range wireless communication network, or the like) or may communicate with another electronic apparatus 2204 and/or a server 2208 through a second network 2299 (e.g., a long distance wireless communication network). The electronic apparatus 2201 may communicate with the electronic apparatus 2204 through the server 2208. The electronic apparatus 2201 may include a processor 2220, a memory 2230, an input device 2250, a sound output device 2255, a display device 2260, an audio module 2270, a sensor module 2210, an interface 2277, a haptic module 2279, a camera module 2280, a power management module 2288, a battery 2289, a communication module 2290, a subscriber identification module 2296, and/or an antenna module 2297. In the electronic apparatus 2201, some of these components (e.g., the display device 2260) may be omitted or other components may be added. Some of these components may be implemented as one integrated circuit. For example, a fingerprint sensor 2211 of the sensor module 2210, an iris sensor, an illuminance sensor, or the like may be implemented in a form embedded in the display device 2260 (e.g., a display, or the like).

The processor 2220 may execute software (e.g., a program 2240) to control one or a plurality of other components (e.g., hardware, software components, or the like) of the electronic apparatus 2201 connected to the processor 2220, and may perform various data processing or operations. As a part of data processing or calculations, the processor 2220 may load commands and/or data received from other components (e.g., the sensor module 2210, the communication module 2290, or the like) into a volatile memory 2232, process commands and/or data stored in the volatile memory 2232, and store resulting data in a non-volatile memory 2234. The processor 2220 may include a main processor 2221 (e.g., a central processing unit, an application processor, or the like) and an auxiliary processor 2223 (e.g., a graphics processing unit, an image signal processor, a sensor hub processor, a communication processor, or the like) that may be operated independently or together with the main processor 2221. The auxiliary processor 2223 may use less power than the main processor 2221 and may perform a specialized function.

The auxiliary processor 2223 may control functions and/or states related to some of the components (e.g., the display device 2260, the sensor module 2210, the communication module 2290) of the electronic apparatus 2201 instead of the main processor 2221 while the main processor 2221 is in an inactive state (sleep state), or together with the main processor 2221 while the main processor 2221 is in an active state (application execution state). The auxiliary processor 2223 (e.g., an image signal processor, a communication processor, or the like) may be implemented as a part of other functionally related components (e.g., the camera module 2280, the communication module 2290, or the like).

The memory 2230 may store various data required by components of the electronic apparatus 2201 (e.g., the processor 2220, the sensor module 2276, or the like). The data may include, for example, software (e.g., the program 2240) and input data and/or output data related to commands for the software. The memory 2230 may include a volatile memory 2232 and/or a non-volatile memory 2234.

The program 2240 may be stored as software in the memory 2230, and may include an operating system 2242, middleware 2244, and/or an application 2246.

The input device 2250 may receive commands and/or data to be used in a component (e.g., the processor 2220) of the electronic apparatus 2201 from the outside of the electronic apparatus 2201 (e.g., a user). The input device 2250 may include a microphone, a mouse, a keyboard, and/or a digital pen (e.g., a stylus pen or the like).

The sound output device 2255 may output a sound signal to an outside of the electronic apparatus 2201. The sound output device 2255 may include a speaker and/or a receiver. The speaker may be used for general purposes, such as, but not limited to, multimedia playback or recording playback, and the receiver may be used to receive incoming calls. The receiver may be integrated as a part of the speaker or may be implemented as an independent separate device.

The display device 2260 may visually provide information to the outside of the electronic apparatus 2201. The display device 2260 may include a display, a hologram device, or a projector and a control circuit for controlling a corresponding device. The display device 2260 may include a touch circuitry configured to sense a touch, and/or a sensor circuitry (e.g., a pressure sensor, or the like) set to measure the intensity of force generated by the touch.

The audio module 2270 may convert a sound into an electric signal or, conversely, convert an electric signal into a sound. The audio module 2270 may acquire a sound through the input device 2250 or may output a sound through a speaker and/or headphone of the sound output device 2255 and/or another electronic apparatus (e.g., the electronic apparatus 2202) directly or wirelessly connected to the electronic apparatus 2201.

The sensor module 2210 may sense an operating state (e.g., power, temperature, or the like) of the electronic apparatus 2201 or an external environmental state (e.g., user state, or the like), and may generate an electrical signal and/or data value corresponding to a sensed state. The sensor module 2210 may include a fingerprint sensor 2211, an acceleration sensor 2212, a position sensor 2213, a 3D sensor 2214, and the like, and in addition to the above sensors, may further include an iris sensor, a gyro sensor, a barometric pressure sensor, a magnetic sensor, a grip sensor, a proximity sensor, a color sensor, an infrared (IR) sensor, a biometric sensor, a temperature sensor, a humidity sensor, and/or an illuminance sensor.

The 3D sensor 2214 may sense a shape and a movement of a target object by irradiating a predetermined light to the target object and analyzing light reflected from the target object, and may be employed in the LiDAR device 1000 including the focal plane array system 100 described with reference to FIGS. 1 to 8 and FIG. 13.

The interface 2277 may support one or more designated protocols that may be used to allow the electronic apparatus 2201 to connect directly or wirelessly with another electronic apparatus (e.g., the electronic apparatus 2202). The interface 2277 may include a high definition multimedia interface (HDMI), a universal serial bus (USB) interface, an SD card interface, and/or an audio interface.

A connection terminal 2278 may include a connector through which the electronic apparatus 2201 may be physically connected to another electronic apparatus (e.g., the electronic apparatus 2202). The connection terminal 2278 may include an HDMI connector, a USB connector, an SD card connector, and/or an audio connector (e.g., a headphone connector).

A haptic module 2279 may convert an electrical signal into a mechanical stimulus (e.g., vibration, movement, or the like) or an electrical stimulus that the user may perceive through tactile or kinesthetic sense. The haptic module 2279 may include a motor, a piezoelectric element, and/or an electrical stimulation device.

The camera module 2280 may capture still images and moving images. The camera module 2280 may include a lens assembly including one or more lenses, image sensors, image signal processors, and/or flashes. The lens assembly included in the camera module 2280 may collect light emitted from a subject, which is an imaging target.

The power management module 2288 may manage power supplied to the electronic apparatus 2201. The power management module 2288 may be implemented as part of a power management integrated circuit (PMIC).

The battery 2289 may supply power to components of the electronic apparatus 2201. The battery 2289 may include a non-rechargeable primary cell, a rechargeable secondary cell, and/or a fuel cell.

The communication module 2290 may establish a direct (wired) communication channel and/or wireless communication channel between the electronic apparatus 2201 and other electronic apparatuses (e.g., the electronic apparatus 2202, an electronic apparatus 2204, server 2208, or the like) and may support a performance of communication through the established communication channels. The communication module 2290 may include one or more communication processors that operate independently of the processor 2220 (e.g., an application processor) and support direct communication and/or wireless communication. The communication module 2290 may include a wireless communication module 2292 (e.g., a cellular communication module, a short-range wireless communication module, a global navigation satellite system (GNSS) communication module, or the like) and/or a wired communication module 2294 (e.g., a Local Area Network (LAN) communication module, or a power line communication module, or the like). Among these communication modules, a corresponding communication module may communicate with other electronic apparatuses through the first network 2298 (e.g., a short-range communication network, such as, but not limited to, Bluetooth™, Wireless-Fidelity (Wi-Fi) Direct, or Infrared Data Association (IrDA), or the like) or the second network 2299 (e.g., a telecommunication network, such as, but not limited to, a cellular network, an Internet, or a computer network (LAN, wide-area network (WAN), or the like)). The various types of communication modules may be integrated into one component (e.g., a single chip, or the like) and/or implemented as a plurality of components (plural chips) separate from each other. The wireless communication module 2292 may identify and/or authenticate the electronic apparatus 2201 within a communication network, such as, but not limited to, the first network 2298 and/or the second network 2299 by using subscriber information (e.g., international mobile subscriber identifier (IMSI)) stored in a subscriber identification module 2296.

The antenna module 2297 may transmit and/or receive signals and/or power to and from an outside (e.g., other electronic apparatuses, or the like). An antenna may include a radiator having a conductive pattern formed on a substrate (e.g., PCB, or the like). The antenna module 2297 may include one or a plurality of antennas. When the plurality of antennas is included in the antenna module 2297, an antenna suitable for a communication manner used in a communication network, such as, but not limited to, the first network 2298 and/or the second network 2299 from among the plurality of antennas may be selected by the communication module 2290. Signals and/or power may be transmitted or received between the communication module 2290 and another electronic apparatus through the selected antenna. In addition to the antenna, other components (e.g., a radio-frequency integrated circuit (RFIC), or the like) may be included as a part of the antenna module 2297.

Some of the components are connected to each other through a communication manner between peripheral devices (e.g., a bus, a general purpose input and output (GPIO), a serial peripheral interface (SPI), a mobile industry processor interface (MIPI), or the like), and may interchange signals (e.g., commands, data, or the like).

The command and/or data may be transmitted and/or received between the electronic apparatus 2201 and the electronic apparatus 2204 through the server 2208 connected to the second network 2299. The other electronic apparatuses 2202 and 2204 may be the same or different types of the electronic apparatus 2201. All or some of operations performed in the electronic apparatus 2201 may be performed in one or more of the other electronic apparatuses 2202, and 2204. For example, when the electronic apparatus 2201 needs to perform a function or service, the electronic apparatus 2201 may request one or more other electronic apparatuses to perform part or all function or service instead of executing the function or service itself. One or more other electronic apparatuses receiving the request may execute an additional function or service related to the request, and transmit a result of the execution to the electronic apparatus 2201. For this purpose, cloud computing, distributed computing, and/or client-server computing technologies may be used.

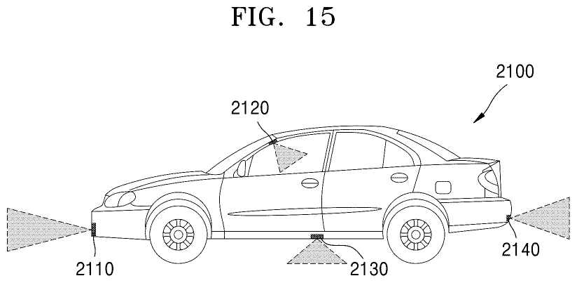

FIG. 15 is a schematic diagram showing an example of applying a LiDAR device to a vehicle 2100, according to an embodiment.

Referring to FIG. 15, the vehicle 2100 may include a plurality of LiDAR devices (e.g., a first LiDAR device 2110, a second LiDAR device 2120, a third LiDAR device 2130, and a fourth LiDAR device 2140) arranged at various locations of the vehicle 2100. The vehicle 2100 may provide a driver with various information about surroundings of the vehicle 2100 using the plurality of LiDAR devices 2110 to 2140, and may provide information necessary for autonomous driving by automatically recognizing things or people around the vehicle 2100. The plurality of LiDAR devices 2110 to 2140 may use, for example, a time-of-flight (TOF) manner to acquire information about a target object. The vehicle 2100 may be, for example, a car with an autonomous driving function. A target object, that is, a things or person in a direction in which the vehicle 2100 is moving may be sensed by using the plurality of LiDAR devices 2110 to 2140, and a distance to the target object may be measured using information such as, but not limited to, a time difference between a transmitted signal and a received signal. In addition, information about nearby target objects and distant target objects within a target area may be obtained.

The plurality of LiDAR devices 2110 to 2140 may employ the LiDAR device 1000 including the focal plane array system 100 described with reference to FIGS. 1 to 8 and FIG. 13.

In FIG. 15, the application of LiDAR devices to a vehicle is shown as an example, however, embodiments of the present disclosure are not limited thereto. The LiDAR device may be applied to flying target objects such as, but not limited to, drones, mobile devices, small walking means (e.g., bicycles, motorcycles, baby strollers, boards, or the like), robots, human/animal assistance means (e.g., canes, helmets, accessories, clothing, watches, bags, or the like), Internet of Things (IoT) devices/systems, security devices/systems, or the like.

As described above, the focal plane array system 100, according to an embodiment, may undergo a process in which only the interference light beam Lo proceeds through the waveguide 210 in a plane, and thus, a light loss occurring in an photonic contact circuit may be minimized, thereby maximizing the signal-to-noise ratio of the interference signal. Therefore, the focal plane array system 100, according to an embodiment, may minimize the light loss occurring in plane of the photonic integrated circuit, and thus, may implement an FMCW-based LiDAR device or distance measurement system with relatively high energy efficiency. In addition, the focal plane array system 100, according to an embodiment, may be applied to a chip-type LiDAR device (e.g., a LiDAR chip) and thus may be mounted on a LiDAR product used for autonomous vehicles and robots. In addition, an optical interferometer structure based on the photonic integrated circuit chip used in the focal plane array system 100, according to an embodiment, may be used in various optical sensor systems.

Although the focal plane array system 100 described above, the LiDAR device including the same, and a device including the LiDAR device have been described with reference to the embodiments illustrated in the drawings, these are merely examples, and it is to be understood by those of ordinary skill in the art that various changes in form and details may be made therein without departing from the spirit and scope of the present disclosure.

Additionally, the disclosure may have the following configuration.

The following aspects are illustrative only and aspects thereof may be combined with aspects of other embodiments or teachings described herein, without limitation.

Aspect 1 is a focal plane array system including a plurality of pixels that output a first signal light beam and receive a second signal light beam reflected from a target object. Each of the plurality of pixels includes a transmitter including a laser element that emits the first signal light beam, a receiver including a photodetector that receives a light beam, and an interference light beam controller including a splitter arranged on an emission path of the first signal light beam to split a portion of the first signal light beam into an interference light beam, a receiving coupler arranged on a receiving path of the second signal light beam reflected from the target object, and a waveguide that proceeds the interference light beam split from the splitter to the receiving coupler. The receiving coupler passes the second signal light beam reflected from the target object to the receiver and couples the interference light beam to the receiver together with the second signal light beam. A first direction in which the first signal light beam proceeds from the transmitter to the splitter is different from a second direction in which the interference light beam proceeds to the waveguide.

In Aspect 2, in the focal plane array system of Aspect 1, the splitter, the receiving coupler, and the waveguide are provided in plane.

In Aspect 3, in the focal plane array system of Aspect 1 or 2, the splitter includes a transmitting grating coupler that couples a portion of the first signal light beam to the waveguide as the interference light beam, and the receiving coupler includes a receiving grating coupler that passes the second signal light beam reflected from the target object and couples the interference light beam to proceed to the receiver together with the second signal light beam.

In Aspect 4, in the focal plane array system of any of Aspects 1 to 3, the transmitting grating coupler, the waveguide, and the receiving grating coupler are formed to be connected to each other in the same plane.

In Aspect 5, in the focal plane array system of any of Aspects 1 to 4, the transmitting grating coupler and the receiving grating coupler have a tapered shape with a width narrowing toward the waveguide.

In Aspect 6, in the focal plane array system of any of Aspects 1 to 5, the laser element includes an array of a plurality of coherent laser elements.

In Aspect 7, in the focal plane array system of any of Aspects 1 to 6, the transmitting grating coupler is provided to overlap with the second signal light beam emitted from some among the plurality of coherent laser elements.

In Aspect 8, in the focal plane array system of any of Aspects 1 to 7, the splitter includes a plurality of splitters spaced apart from each other, the receiving coupler includes a plurality of receiving couplers arranged between the plurality of splitters, the waveguide is provided to connect adjacent splitter and receiving coupler to each other, the transmitter further includes a beam scanner that scans the first signal light beam emitted from the laser element to be sequentially input into the plurality of splitters, and the photodetector includes a plurality of photodetectors corresponding to the plurality of receiving couplers.

In Aspect 9, in the focal plane array system of any of Aspects 1 to 8, the splitter includes a transmitting grating coupler that couples a portion of the first signal optical beam to the waveguide as the interference optical beam, and the receiving coupler includes a receiving grating coupler that passes the second signal light beam reflected from the target object and couples the interference light beam to proceed to the receiver together with the second signal light beam.

In Aspect 10, in the focal plane array system of any of Aspects 1 to 9, the splitter is an omnidirectional coupler, the waveguide includes a plurality of waveguides arranged radially to be connected to the omnidirectional coupler, the receiving coupler includes a plurality of receiving grating couplers connected to each of the plurality of waveguides, and the pixel includes a plurality of sub-pixels.

In Aspect 11, in the focal plane array system of any of Aspects 1 to 10, the omnidirectional coupler, the waveguide, and the receiving grating coupler are formed to be connected to each other in the same plane.

In Aspect 12, in the focal plane array system of any of Aspects 1 to 11, the receiving grating coupler has a tapered shape with a width narrowing toward the waveguide.

In Aspect 13, in the focal plane array system of any of Aspects 1 to 12, the transmitter includes a first micro lens that condenses the first signal light beam emitted from the laser element, the receiver includes a second micro lens that converges the interference light beam together with the second signal light beam reflected from the target object onto the photodetector, the laser element and the photodetector are provided in a first substrate. The first micro lens and the second micro lens are provided in a second substrate that is different from the first substrate.

In Aspect 14, in the focal plane array system of any of Aspects 1 to 13, the splitter includes a first meta surface lens that condenses the first signal light beam emitted from the laser element and couples a portion of the first signal light beam to proceed into the waveguide as the interference light beam, and the receiving coupler includes a second meta surface lens that couples a portion of the interference light beam to converge onto the photodetector together with the second signal light beam reflected from the target object. The laser element and the photodetector are provided in a first substrate. The first meta surface lens and the second meta surface lens are provided in a substrate that is different from the first substrate.

Aspect 15 is a LiDAR device including a focal plane array system including a plurality of pixels that output a first signal light beam and receive a second signal light beam reflected from a target object, and a processor that performs a calculation for acquiring information about the target object. Each of the plurality of pixels of the focal plane array system includes a transmitter including a laser element that outputs the first signal light beam, a receiver including a photodetector that receives a light beam, and an interference light beam controller including a splitter arranged on an emission path of the first signal light beam to split a portion of the first signal light beam into an interference light beam, a receiving coupler arranged on a receiving path of the second signal light beam reflected from the target object, and a waveguide that proceeds the interference light beam split from the splitter to the receiving coupler. The receiving coupler passes the second signal light beam reflected from the target object to the receiver and couples the interference light beam to the receiver together with the second signal light beam. A first direction in which the first signal light beam proceeds from the transmitter to the splitter is different from a second direction in which the interference light beam proceeds to the waveguide.

In Aspect 16, in the LiDAR device of Aspect 15, the splitter, the receiving coupler, and the waveguide are arranged in plane.

In Aspect 17, in the LiDAR device of Aspect 15 or 16, the splitter includes a transmitting grating coupler that couples a portion of the first signal light beam to the waveguide as the interference light beam, and the receiving coupler includes a receiving grating coupler that passes the second signal light beam reflected from the target object and couples the interference light beam to proceed to the receiver together with the second signal light beam.

In Aspect 18, in the LiDAR device of any of the Aspects 15 to 17, the transmitting grating coupler and the receiving grating coupler have a tapered shape with a width narrowing toward the waveguide.

In Aspect 19, in the LiDAR device of any of the Aspects 15 to 18, the splitter includes a plurality of splitters spaced apart from each other, the receiving coupler includes a plurality of receiving couplers arranged between the plurality of splitters, the waveguide is provided to connect adjacent splitter and receiving coupler to each other, the transmitter further includes a beam scanner that scans the first signal light beam emitted from the laser element to be sequentially input into the plurality of splitters, and the photodetector includes a plurality of photodetectors corresponding to the plurality of receiving couplers.

In Aspect 20, in the LiDAR device of any of the Aspects 15 to 19, the splitter is an omnidirectional coupler, the waveguide includes a plurality of waveguides arranged radially to be connected to the omnidirectional coupler, the receiving coupler includes a plurality of receiving grating couplers connected to each of the plurality of waveguides, and the pixel includes a plurality of sub-pixels.

Aspect 21 is a device including a LiDAR device. The LiDAR device including a focal plane array system including a plurality of pixels that output a first signal light beam and receive a second signal light beam reflected from a target object, and a processor that performs a calculation for acquiring information about the target object. wherein each of the plurality of pixels of the focal plane array system includes a transmitter including a laser element that outputs the first signal light beam, a receiver including a photodetector that receives a light beam, and an interference light beam controller including a splitter arranged on an emission path of the first signal light beam to split a portion of the first signal light beam into an interference light beam, a receiving coupler arranged on a receiving path of the second signal light beam reflected from the target object, and a waveguide that proceeds the interference light beam split from the splitter to the receiving coupler. The receiving coupler passes the second signal light beam reflected from the target object to the receiver and couples the interference light beam to the receiver together with the second signal light beam. A first direction in which the first signal light beam proceeds from the transmitter to the splitter is different from a second direction in which the interference light beam proceeds to the waveguide.

In Aspect 22, in the device including the LiDAR device of Aspect 22, the splitter, the receiving coupler, and the waveguide are arranged in plane.

In Aspect 23, in the device including a LiDAR device of Aspect 21 or 22, the splitter includes a transmitting grating coupler that couples a portion of the first signal light beam to the waveguide as the interference light beam, the receiving coupler includes a receiving grating coupler that passes the second signal light beam reflected from the target object and couples the interference light beam to proceed to the receiver together with the second signal light beam.

The focal plane array system, according to an embodiment, and the LiDAR device including the same may be suitable for implementing silicon photonics-based LiDAR since only the interference light beam goes through a process of propagating through the waveguide in plane, and thus, may minimize light loss occurring in plane.

In addition, the focal plane array system suitable for the FMCW driving manner and the LiDAR device including the same may be implemented, and light loss occurring in a photonic integrated circuit may be minimized, and thus, a signal-to-noise ratio of the interference signal may be significantly improved.

It is to be understood that embodiments described herein should be considered in a descriptive sense only and not for purposes of limitation. Descriptions of features or aspects within each embodiment may typically be considered as available for other similar features or aspects in other embodiments. While one or more embodiments have been described with reference to the figures, it is to be understood by those of ordinary skill in the art that various changes in form and details may be made therein without departing from the spirit and scope as defined by the following claims.

What is claimed is:

1. A focal plane array system, comprising:
a plurality of pixels configured to output a first signal light beam and to receive a second signal light beam reflected from a target object,
wherein each of the plurality of pixels comprises:
a transmitter comprising a laser element configured to emit the first signal light beam;
a receiver comprising a photodetector configured to receive the second signal light beam; and
an interference light beam controller comprising:
a splitter disposed on an emission path of the first signal light beam to split a portion of the first signal light beam into an interference light beam;
a receiving coupler disposed on a receiving path of the second signal light beam reflected from the target object; and
a waveguide configured to transport the interference light beam split from the splitter to the receiving coupler,
wherein the receiving coupler is configured to transport the second signal light beam reflected from the target object to the receiver and to combine the interference light beam with the second signal light beam, and
wherein a first direction in which the first signal light beam proceeds from the transmitter to the splitter is different from a second direction in which the interference light beam proceeds to the waveguide.

2. The focal plane array system of claim 1, wherein the splitter, the receiving coupler, and the waveguide are provided in a same plane.

3. The focal plane array system of claim 1, wherein the splitter comprises a transmitting grating coupler coupling the portion of the first signal light beam to the waveguide as the interference light beam, and
wherein the receiving coupler comprises a receiving grating coupler configured to transport the second signal light beam reflected from the target object to the receiver and to combine the interference light beam with the second signal light beam.

4. The focal plane array system of claim 3, wherein the transmitting grating coupler, the waveguide, and the receiving grating coupler are formed to be coupled with each other in a same plane.

5. The focal plane array system of claim 3, wherein the transmitting grating coupler and the receiving grating coupler comprise a tapered shape with a width narrowing toward the waveguide.

6. The focal plane array system of claim 3, wherein the laser element comprises an array of a plurality of coherent laser elements.

7. The focal plane array system of claim 6, wherein the transmitting grating coupler is further configured to at least partially overlap the second signal light beam emitted from at least one of the plurality of coherent laser elements.

8. The focal plane array system of claim 1, wherein the splitter comprises a plurality of splitters spaced apart from each other,
wherein the receiving coupler comprises a plurality of receiving couplers disposed between the plurality of splitters,
wherein the waveguide is configured to couple a first splitter of the plurality of splitters with a first receiving coupler of the plurality of receiving couplers, the first splitter being adjacent to the first receiving coupler,
wherein the transmitter further comprises a beam scanner configured to scan the first signal light beam emitted from the laser element to be sequentially input into the plurality of splitters, and
wherein the photodetector comprises a plurality of photodetectors corresponding to the plurality of receiving couplers.

9. The focal plane array system of claim 8, wherein the splitter further comprises a transmitting grating coupler configured to couple the portion of the first signal light beam to the waveguide as the interference light beam, and
wherein the receiving coupler further comprises a receiving grating coupler configured to transport the second signal light beam reflected from the target object to the receiver and to combine the interference light beam with the second signal light beam.

10. The focal plane array system of claim 1, wherein the splitter comprises an omnidirectional coupler,
wherein the waveguide comprises a plurality of waveguides disposed radially to be coupled with the omnidirectional coupler,
wherein the receiving coupler comprises a plurality of receiving grating couplers coupled with each of the plurality of waveguides, and
wherein each pixel of the plurality of pixels comprises a plurality of subpixels.

11. The focal plane array system of claim 10, wherein the omnidirectional coupler, the waveguide, and the plurality of receiving grating couplers are formed to be coupled with each other in a same plane.

12. The focal plane array system of claim 10, wherein each of the plurality of receiving grating couplers comprises a tapered shape with a width narrowing toward the waveguide.

13. The focal plane array system of claim 1, wherein the transmitter comprises a first micro lens configured to condense the first signal light beam emitted from the laser element,
wherein the receiver comprises a second micro lens configured to converge the interference light beam with the second signal light beam reflected from the target object onto the photodetector,
wherein the laser element and the photodetector are provided in a first substrate, and
wherein the first micro lens and the second micro lens are provided in a second substrate different from the first substrate.

14. The focal plane array system of claim 1, wherein the splitter comprises a first meta surface lens configured to condense the first signal light beam emitted from the laser element and to couple the portion of the first signal light beam into the waveguide as the interference light beam,
wherein the receiving coupler comprises a second meta surface lens configured to combine a portion of the interference light beam with the second signal light beam reflected from the target object, and to converge the combined signal light beam onto the photodetector,
wherein the laser element and the photodetector are provided in a first substrate, and
wherein the first meta surface lens and the second meta surface lens are provided in a second substrate different from the first substrate.

15. A light detection and ranging (LiDAR) device comprising:
a focal plane array system comprising a plurality of pixels configured to output a first signal light beam and to receive a second signal light beam reflected from a target object, and a processor configured to calculate information of the target object,
wherein each of the plurality of pixels comprises:
a transmitter comprising a laser element configured to output the first signal light beam;
a receiver comprising a photodetector configured to receive the second signal light beam; and
an interference light beam controller comprising:
a splitter disposed on an emission path of the first signal light beam to split a portion of the first signal light beam into an interference light beam;
a receiving coupler disposed on a receiving path of the second signal light beam reflected from the target object; and
a waveguide configured to transport the interference light beam split from the splitter to the receiving coupler,
wherein the receiving coupler is configured to transport the second signal light beam reflected from the target object to the receiver and to combine the interference light beam with the second signal light beam,
wherein a first direction in which the first signal light beam proceeds from the transmitter to the splitter is different from a second direction in which the interference light beam proceeds to the waveguide.

16. The LiDAR device of claim 15, wherein the splitter, the receiving coupler, and the waveguide are disposed in a same plane.

17. The LiDAR device of claim 15, wherein the splitter comprises a transmitting grating coupler coupling the portion of the first signal light beam to the waveguide as the interference light beam, and
wherein the receiving coupler comprises a receiving grating coupler configured to transport the second signal light beam reflected from the target object to the receiver and to combine the interference light beam with the second signal light beam.

18. The LiDAR device of claim 17, wherein the transmitting grating coupler and the receiving grating coupler comprise a tapered shape with a width narrowing toward the waveguide.

19. The LiDAR device of claim 15, wherein the splitter comprises a plurality of splitters spaced apart from each other,
wherein the receiving coupler comprises a plurality of receiving couplers disposed between the plurality of splitters,
wherein the waveguide is configured to couple a first splitter of the plurality of splitters with a first receiving coupler of the plurality of receiving couplers, the first splitter being adjacent to the first receiving coupler,
wherein the transmitter further comprises a beam scanner configured to scan the first signal light beam emitted from the laser element to be sequentially input into the plurality of splitters, and
wherein the photodetector comprises a plurality of photodetectors corresponding to the plurality of receiving couplers.

20. The LiDAR device of claim 15, wherein the splitter comprises an omnidirectional coupler,
wherein the waveguide comprises a plurality of waveguides disposed radially to be coupled with the omnidirectional coupler,
wherein the receiving coupler comprises a plurality of receiving grating couplers coupled with each of the plurality of waveguides, and
wherein each pixel of the plurality of pixels comprises a plurality of subpixels.
